(19) United States
(12) Patent Application Publication
(10) Pub. No.: US 2025/0383020 A1
(43) Pub. Date: Dec. 18, 2025

(54) GATE GUIDE FOR GATE VALVE

(71) Applicant: VALVEWORKS USA, INC., Bossier City, LA (US)

(72) Inventor: Todd Roberts, Bossier City, LA (US)

(21) Appl. No.: 19/233,566

(22) Filed: Jun. 10, 2025

Related U.S. Application Data
(60) Provisional application No. 63/659,618, filed on Jun. 13, 2024.

(51) Int. Cl. F16K 3/316; F16K 27/04

(52) U.S. Cl. CPC F16K 3/316; F16K 27/044

(57) ABSTRACT

A gate guide for a gate valve, the gate guide including opposing first and second end faces, an internal region formed through the first end face, an outer surface encompassing the gate guide, including the internal region, between the opposing first and second end faces, and opposing first and second recesses formed through both the outer surface and the first end face on opposing sides of the internal region. The internal region of the gate guide is adapted to receive a gate body of the gate valve, and the opposing first and second recesses of the gate guide are adapted to receive opposing first and second seat elements, respectively, of the gate valve when the gate body is seated against the opposing first and second seat elements in a valve body of the gate valve so as to be movable between the open configuration and the closed configuration.

### CROSS-REFERENCE TO RELATED APPLICATION

This application claims the benefit of the filing date of, and priority to, U.S. Application No. 63/659,618, filed Jun. 13, 2024, the entire disclosure of which is hereby incorporated herein by reference.

### TECHNICAL FIELD

The present application relates generally to gate valves, and, more particularly, to a gate guide for reducing the grease volume of a gate valve.

### BRIEF DESCRIPTION OF THE DRAWINGS

FIG. 1A illustrates a gate valve, according to one or more embodiments of the present disclosure.

FIG. 1B is an enlarged view of a portion 1B of the gate valve in FIG. 1A, according to one or more embodiments of the present disclosure.

FIG. 2A illustrates another gate valve, according to one or more embodiments of the present disclosure.

FIG. 2B is an enlarged view of a portion 2B of the another gate valve in FIG. 2A, according to one or more embodiments of the present disclosure.

FIG. 3 illustrates an operating end bonnet assembly, a balancing end bonnet assembly, a gate body, a first valve seat, and a second valve seat of the another gate valve of FIG. 2A, according to one or more embodiments of the present disclosure.

FIG. 4 illustrates the operating end bonnet assembly of FIG. 3, according to one or more embodiments of the present disclosure.

FIG. 5 illustrates the balancing end bonnet assembly of FIG. 3, according to one or more embodiments of the present disclosure.

FIG. 6A illustrates a gate guide of the balancing end bonnet assembly of FIG. 5, according to one or more embodiments of the present disclosure.

FIG. 6B illustrates a cross-section of the gate guide taken along the line 6B-6B of FIG. 6A, according to one or more embodiments of the present disclosure.

FIG. 6C illustrates another cross-section of the gate guide taken along the line 6B-6B of FIG. 6A, according to one or more embodiments of the present disclosure.

### DETAILED DESCRIPTION

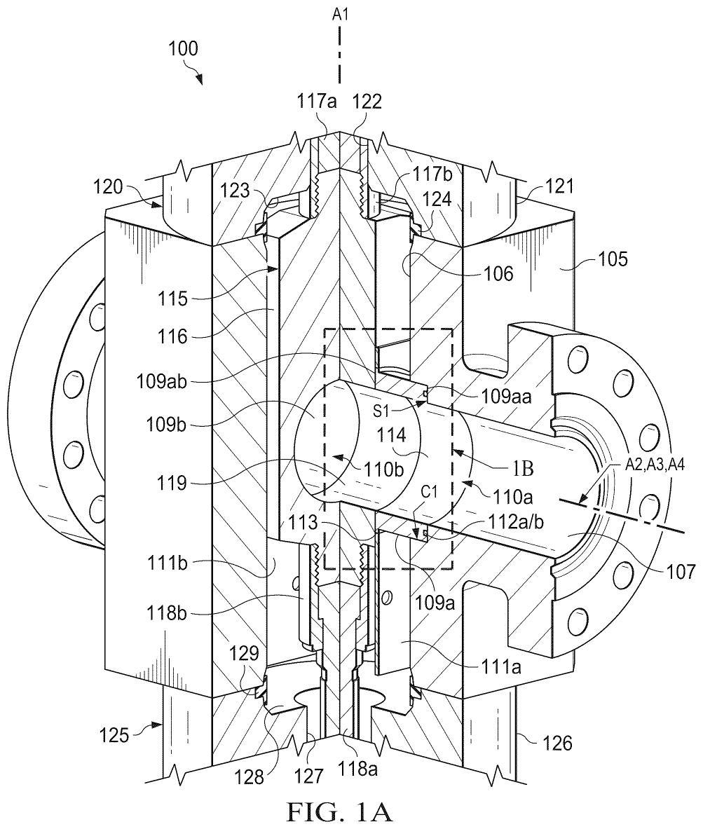

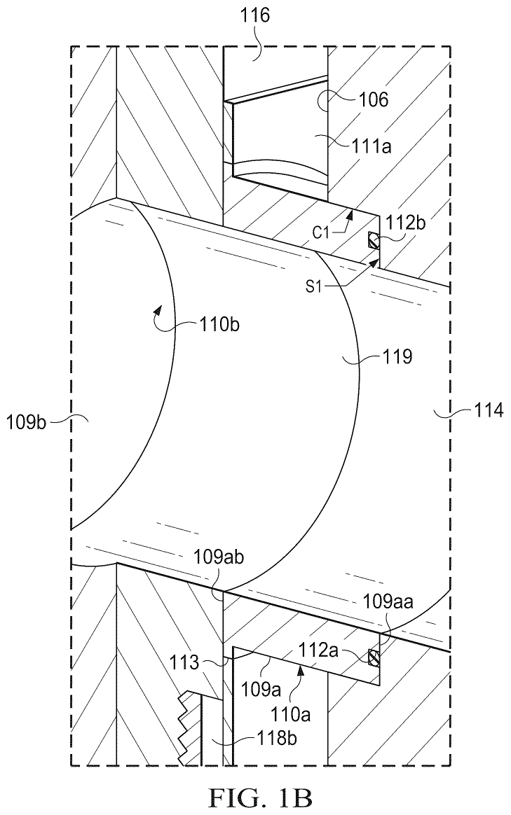

Referring to FIG. 1A, a gate valve 100 is illustrated, according to one or more embodiments of the present disclosure. The gate valve 100 includes a valve body 105, a pair of valve seats 110a, 110b engaged with the valve body 105, a gate assembly 115 extending within the valve body 105 and accommodated by the valve seats 110a, 110b, an operating end bonnet assembly 120 connected to the valve body 105, and a balancing end bonnet assembly 125 connected to the valve body 105, opposite the operating end bonnet assembly 120. The gate assembly 115 is enclosed within the valve body 105, the operating end bonnet assembly 120, and the balancing end bonnet assembly 125. The operating end bonnet assembly 120 is adapted to actuate the gate assembly 115 between a fully-open configuration, in which a fluid is permitted to flow through the valve body 105, and a fully-closed configuration, in which the fluid is restricted from flowing through the valve body 105. The balancing end bonnet assembly 125 accommodates a portion of the gate assembly 115 and balances axial forces such as, for example, hydraulic lift forces, which are exerted on the gate assembly 115 during operation of the gate valve 100. The valve seats 110a, 110b are positioned on either side of the gate assembly 115, and maintain the axial alignment of the gate assembly 115 during the actuation thereof between the fully-open and fully-closed configurations.

Referring also to FIG. 1B, with continuing reference to FIG. 1A, an enlarged view of a portion 1B of the gate valve 100 is illustrated, according to one or more embodiments of the present disclosure. The valve body 105 includes an internal region 106, such as, for example, a passage or bore, extending therethrough along a center axis A1.

In one or more embodiments, the internal region 106 is generally cylindrical. A fluid bore 107 extends through the valve body 105 along a center axis A2 and intersects the internal region 106. In one or more embodiments, the fluid bore 107 is generally cylindrical. In one or more embodiments, the center axis A2 of the fluid bore 107 is substantially perpendicular to the center axis A1 of the internal region 106. An annular recess C1 is formed in the fluid bore 107, adjacent the internal region 106. More particularly, the annular recess C1 adjoins the internal region 106 and defines an annular shoulder S1 in the valve body 105. Another fluid bore (not visible) extends through the valve body 105 along the center axis A2, opposite the fluid bore 107, and intersects the internal region 106. In one or more embodiments, the another fluid bore is generally cylindrical. Another annular recess (not visible) substantially similar to the annular recess C1 is formed in the another fluid bore (not visible), adjacent the internal region 106. More particularly, the another annular recess (not visible) adjoins the internal region 106 and defines another annular shoulder (not visible) in the valve body 105.

The valve seat 110a includes a seat element 109a and a corresponding gate guide 111a. The seat element 109a is a tubular (e.g., generally cylindrical) member defining a pair of opposing end faces 109aa and 109ab. The seat element 109a includes an annular groove 112a formed in the end face 109aa thereof. The annular groove 112a accommodates an annular seal 112b. An annular ridge 113 extends radially outward from an exterior of the seat element 109a, adjacent the end face 109ab. Specifically, in one or more embodiments, the end face 109ab is adjoined, or at least partially defined by, the annular ridge 113. A fluid bore 114 extends through the seat element 109a, along a center axis A3, which is substantially coaxial with the center axis A2. In one or more embodiments, the fluid bore 114 is generally cylindrical. The end face 109aa of the seat element 109a abuts, or nearly abuts, the annular shoulder S1 in the valve body 105. The gate guide 111a circumscribes an exterior of the seat element 109a and is supported, for example, in a substantially parallel relation to a gate guide 111b. Specifically, in one or more embodiments, the gate guide 111a circumscribes the annular ridge 113 of the seat element 109a. For example, at least a portion of the gate guide 111a may be substantially co-planar with the end face 109ab of the seat element 109a.

The valve seat 110b includes a seat element 109b and the corresponding gate guide 111b. In one or more embodiments, the seat element 109b is substantially identical (or at least similar) to the seat element 109a. Thus, an end face (not visible) of the seat element 109b substantially identical (or at least similar) to the end face 109aa of the seat element 109a abuts, or nearly abuts, the another annular shoulder (not visible) in the valve body 105. The gate guide 111b circumscribes an exterior of the seat element 109b and is supported, for example, in a substantially parallel relation to the gate guide 111a. Specifically, in one or more embodiments, the gate guide 111a circumscribes an annular ridge (not visible) of the seat element 109b, which annular ridge is substantially identical (or at least similar) to the annular ridge 113 of the seat element 109a. For example, at least a portion of the gate guide 111b may be substantially co-planar with an end face (not visible) of the seat element 109b, which end face is substantially identical (or at least similar) to the end face 109ab of the seat element 109a.

In one or more embodiments, the gate guide 111b is substantially identical (or at least similar) to the gate guide 111a. In one or more embodiments, the gate guides 111a and 111b are connected to one another. In one or more embodiments, the gate guides 111a and 111b are integrally formed. In one or more embodiments, the gate guides 111a and 111b together define a tubular member.

The gate assembly 115 includes a gate body 116, an operating stem 117a (visible in FIG. 1A) connected to the gate body 116, and a balance stem 118a (visible in FIG. 1A) connected to the gate body 116, opposite the operating stem 117a. A fluid bore 119 extends through the gate body 116 along a center axis A4. In one or more embodiments, the fluid bore 119 is generally cylindrical. The gate body 116 is constrained on one side by the valve seat 110a (including the seat element 109a and the gate guide 111a), and, on the other side, by the valve seat 110b (including the seat element 109b and the gate guide 111b). Constrained as such, the gate body 116 is adapted to move linearly between the fully-open configuration, in which the fluid bore 119 of the gate body 116 is fully aligned with the corresponding fluid bores of the seat elements 109a, 109b, and the fully-closed configuration, in which the fluid bore 119 of the gate body 116 is fully misaligned with the corresponding fluid bores of the seat elements 109a, 109b. The operating stem 117a and the balance stem 118a are connected to opposing end portions of the gate body 116, via a pair of gate nuts 117b and 118b, respectively (visible in FIG. 1A). In one or more embodiments, the operating stem 117a and the balance stem 118a connected to the opposing end portions of the gate body 116 are substantially co-axial. Moreover, in one or more embodiments, the operating stem 117a and the balance stem 118a are substantially co-axial with the center axis A1 of the valve body 105.

Although not exposed to fluid flowing through the gate valve 100, the internal region 106 of the valve body 105 is exposed to well fluid during the stroking of the gate valve 100 between the open configuration and the closed configuration. Thus, the portion of the internal region 106 surrounding the seat elements 109a, 109b and the gate assembly 115 is typically filled with body grease, and may be referred to herein as a “grease volume” of the gate valve 100. The gate guides 111a, 111b help to keep the turbulence of the fluid flowing through the gate valve 100 from washing out the body grease when the gate body 116 is stroked between the opening configuration and the closed configuration.

The operating end bonnet assembly 120 includes a bonnet body 121 (visible in FIG. 1A) and a linear actuator (not visible) such as, for example, a ball-screw assembly connected to the bonnet body 121. The bonnet body 121 is connected to the valve body 105 via, for example, a plurality of fasteners (not visible). An internal passage 122 extends through the bonnet body 121. In one or more embodiments, the internal passage 122 is generally cylindrical. In one or more embodiments, the internal passage 122 of the bonnet body 121 is substantially co-axial with the center axis A1 of the valve body 105. The internal passage 122 accommodates the gate nut 117b of the operating stem 117a when the gate assembly 115 is in the fully-open configuration.

An annular recess 123 is formed in the internal passage 122, adjacent the valve body 105. In addition to the portion of the internal region 106 surrounding the seat elements 109a, 109 and the gate assembly 115, the “grease volume” of the gate valve 100 may also include the annular recess 123 of the bonnet body 121 of the operating end bonnet assembly 120. An annular seal 124 sealingly engages both the valve body 105 and the bonnet body 121. The operating end bonnet assembly 120 also includes a sealing (e.g., packing) element (not visible) that provides both a static and a dynamic seal between the bonnet body 121 and the operating stem 117a of the gate assembly 115. A balancing port (not visible) may be formed through the bonnet body 121 into the internal passage 122. During operation, the balancing port may be placed in communication with fluid exiting the gate valve 100; such fluid communication facilitates the balancing of axial forces such as, for example, hydraulic lift forces, which are exerted on the gate assembly 115.

The balancing end bonnet assembly 125 includes a bonnet body 126 (visible in FIG. 1A). The bonnet body 126 is connected to the valve body 105, opposite the bonnet body 121, via, for example, a plurality of fasteners (not visible). An internal passage 127 extends through the bonnet body 126. In one or more embodiments, the internal passage 127 is generally cylindrical. In one or more embodiments, the internal passage 127 of the bonnet body 126 is substantially co-axial with the center axis A1 of the valve body 105. The internal passage 127 accommodates the gate nut 118b of the balance stem 118a when the gate assembly 115 is in the fully-closed configuration.

An annular recess 128 is formed in the internal passage 127, adjacent the valve body 105. In addition to the portion of the internal region 106 surrounding the seat elements 109a, 109 and the gate assembly 115, the “grease volume” of the gate valve 100 may also include the annular recess 128 of the bonnet body 126 of the balancing end bonnet assembly 125. An annular seal 129 sealingly engages both the valve body 105 and the bonnet body 126. The balancing end bonnet assembly 125 also includes a sealing (e.g., packing) element (not visible) that provides both a static and a dynamic seal between the bonnet body 126 and the balance stem 118a of the gate assembly 115. Another balancing port (not visible) may be formed through the bonnet body 126 into the internal passage 127. During operation, the another balancing port may be placed in communication with the fluid exiting the gate valve 100; such fluid communication facilitates the balancing of axial forces such as, for example, hydraulic lift, exerted on the gate assembly 115.

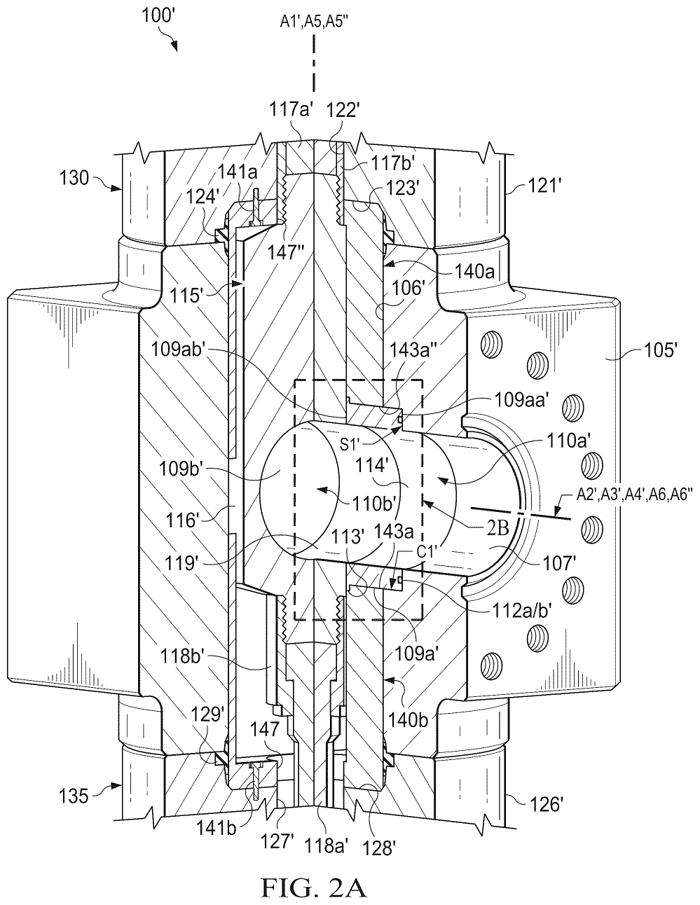

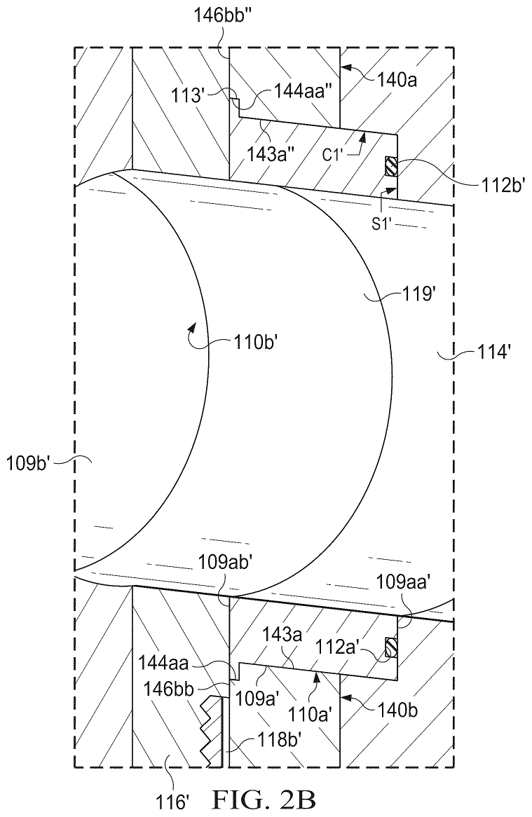

Referring to FIG. 2A, a gate valve 100′ is illustrated, according to one or more embodiments of the present disclosure. The gate valve 100′ includes one or more components substantially identical (or at least similar) to corresponding component(s) of the gate valve 100, which substantially identical (or at least similar) component(s) are given the same reference numerals, except with the suffix “′” added. The operating end bonnet assembly 120 is omitted from the gate valve 100′ and replaced with an operating end bonnet assembly 130. The operating end bonnet assembly 130 includes one or more components substantially identical (or at least similar) to corresponding component(s) of the operating end bonnet assembly 120, which substantially identical (or at least similar) component(s) are given the same reference numerals, except with the suffix “′” added. The gate guides 111a, 111b are also omitted from the gate valve 100′ and replaced with gate guides 140a, 140b (each may also be referred to as a “guide body”). Specifically, the gate guides 140a, 140b replace the gate guides 111a, 111b, while also taking up a significant portion of the grease volume. The gate guide 140a is connected to the bonnet body 121′ of the operating end bonnet assembly 130 and extends within both the annular recess 123′ of the bonnet body 121′ and the internal region 106′ of the valve body 105′. In one or more embodiments, the gate guide 140a includes or is part of the bonnet body 121′. In one or more embodiments, the gate guide 140a includes or is part of the operating end bonnet assembly 130.

The balancing end bonnet assembly 125 is also omitted from the gate valve 100′ and replaced with a balancing end bonnet assembly 135. The balancing end bonnet assembly 135 includes one or more components substantially identical (or at least similar) to corresponding component(s) of the balancing end bonnet assembly 125, which substantially identical (or at least similar) component(s) are given the same reference numerals, except with a suffix “′” added. The gate guide 140b is connected to the bonnet body 126′ of the balancing end bonnet assembly 135 and extends within both the annular recess 128′ of the bonnet body 126′ and the internal region 106′ of the valve body 105′. In one or more embodiments, the gate guide 140b includes or is part of the bonnet body 126′. In one or more embodiments, the gate guide 140b includes or is part of the balancing end bonnet assembly 135.

Referring also to FIG. 2B, with continuing reference to FIG. 2A, an enlarged view of a portion 2B of the gate valve 100′ is illustrated, according to one or more embodiments of the present disclosure. The gate guide 140a occupies the internal cavity 106′ between the valve body 105′ and the gate body 116′, proximate the operating end bonnet assembly 130. The gate guide 140b occupies the internal cavity 106′ between the valve body 105′ and the gate body 116′, proximate the balancing end bonnet assembly 135.

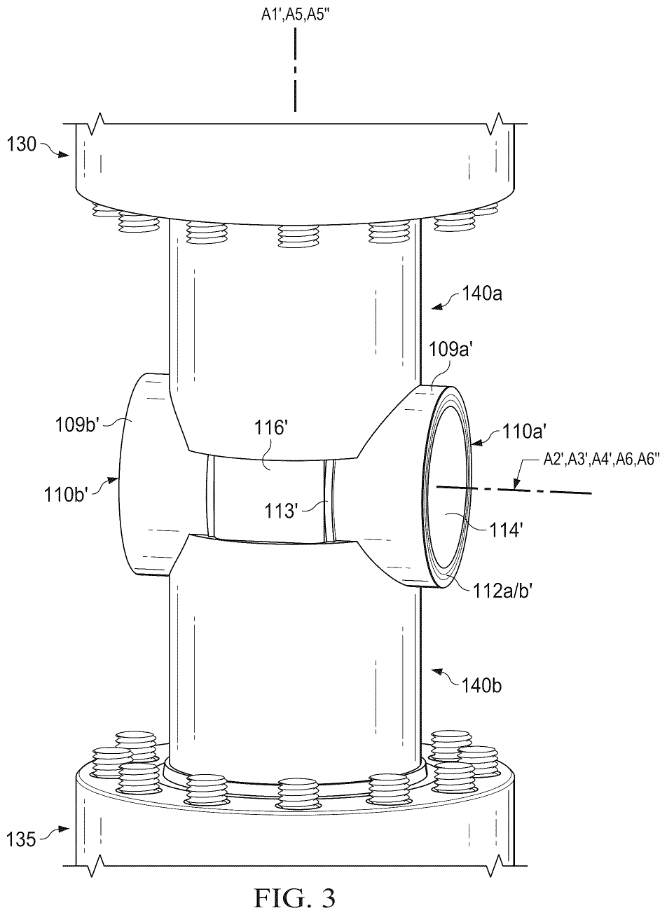

Referring to FIG. 3, with continuing reference to FIGS. 2A-2B, the operating end bonnet assembly 130, the balancing end bonnet assembly 135, the gate body 116′, the valve seats 110a′, 110b′, and the gate guides 140a, 140b are illustrated, according to one or more embodiments of the present disclosure. For clarity, the valve body 105′ is omitted from view.

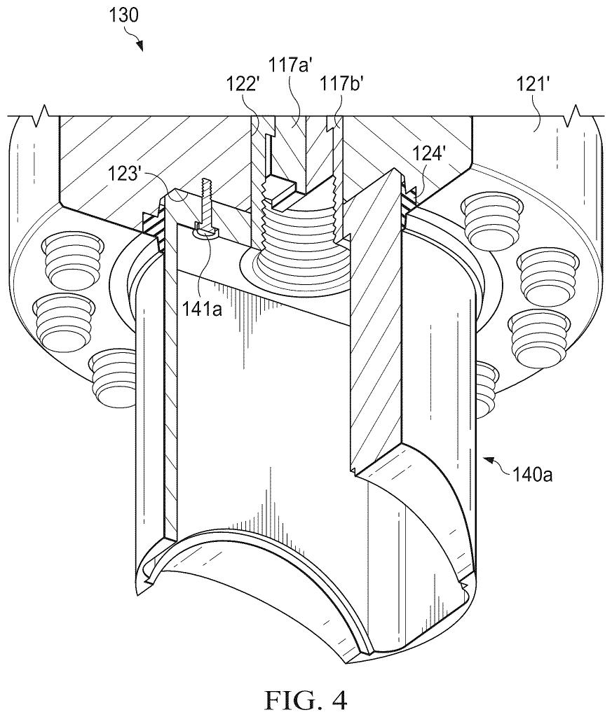

Referring to FIG. 4, with continuing reference to FIG. 3, the operating end bonnet assembly 130, which may be or include the gate guide 140a, is illustrated, according to one or more embodiments of the present disclosure. The gate guide 140a extends within the annular recess 123′ and is connected to the bonnet body 121′ of the operating end bonnet assembly 130 via one or more fasteners 141a (also visible in FIG. 2A). As a result, the bonnet body 121′ and the gate guide 140a move as one during handling and assembly.

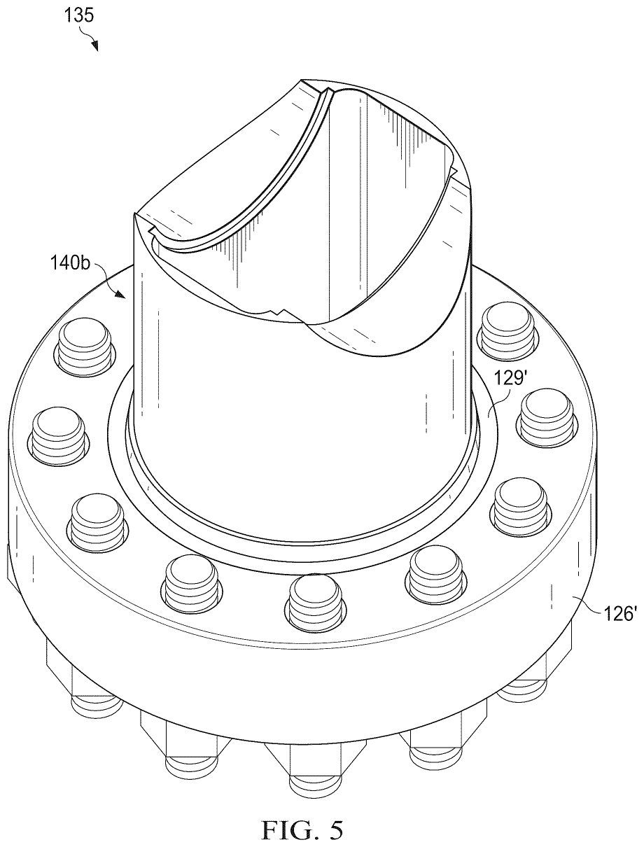

Referring to FIG. 5, with continuing reference to FIG. 3, the balancing end bonnet assembly 135, which may be or include the gate guide 140b, is illustrated, according to one or more embodiments of the present disclosure. The gate guide 140b extends within the annular recess 128′ and is connected to the bonnet body 126′ of the balancing end bonnet assembly 135 via one or more fasteners 141b (not visible in FIG. 5; visible in FIG. 2A). As a result, the bonnet body 126′ and the gate guide 140b move as one during handling and assembly.

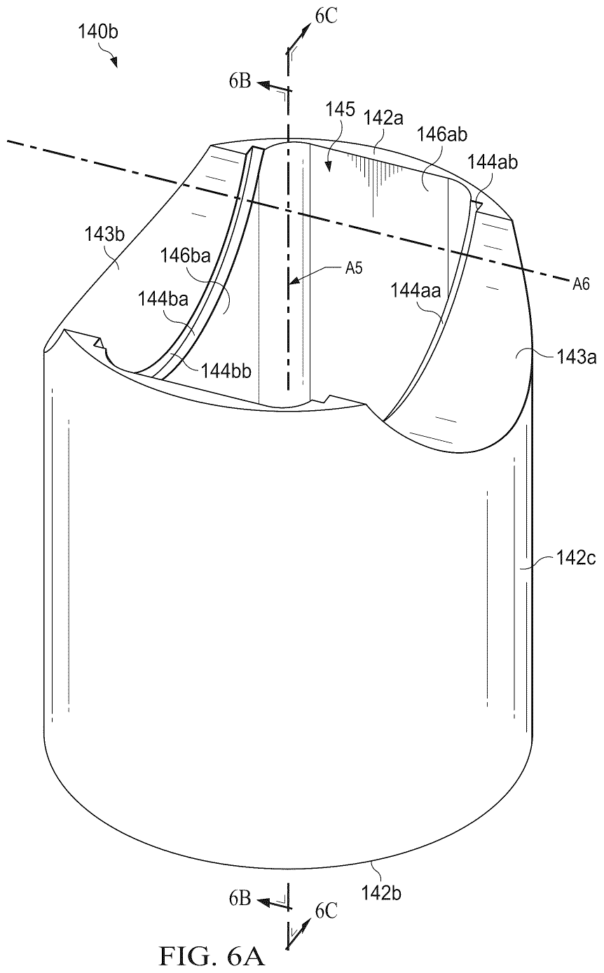

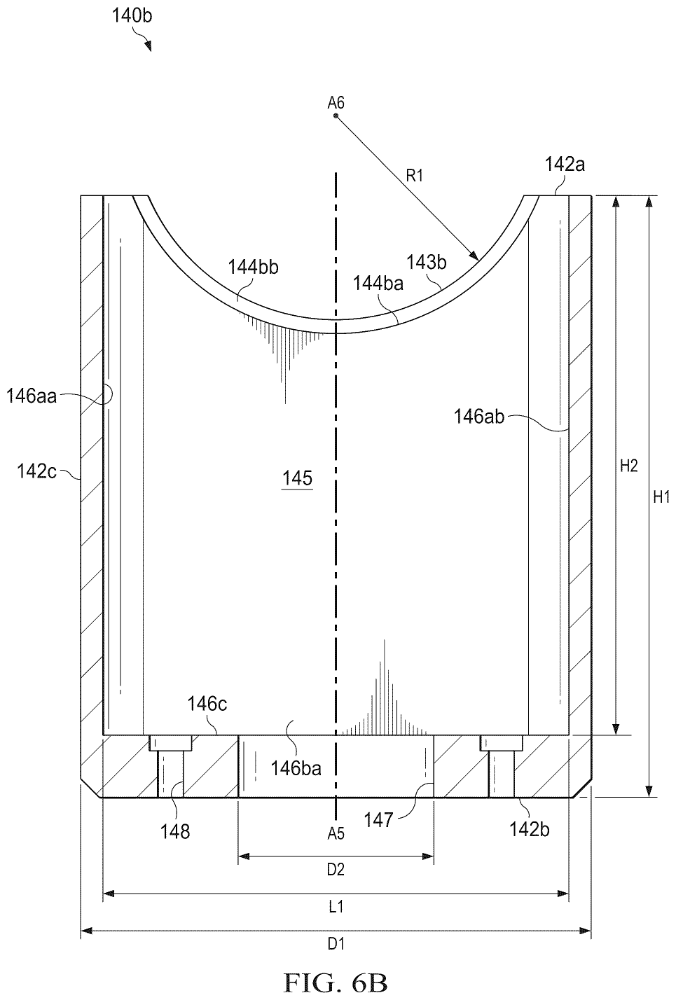

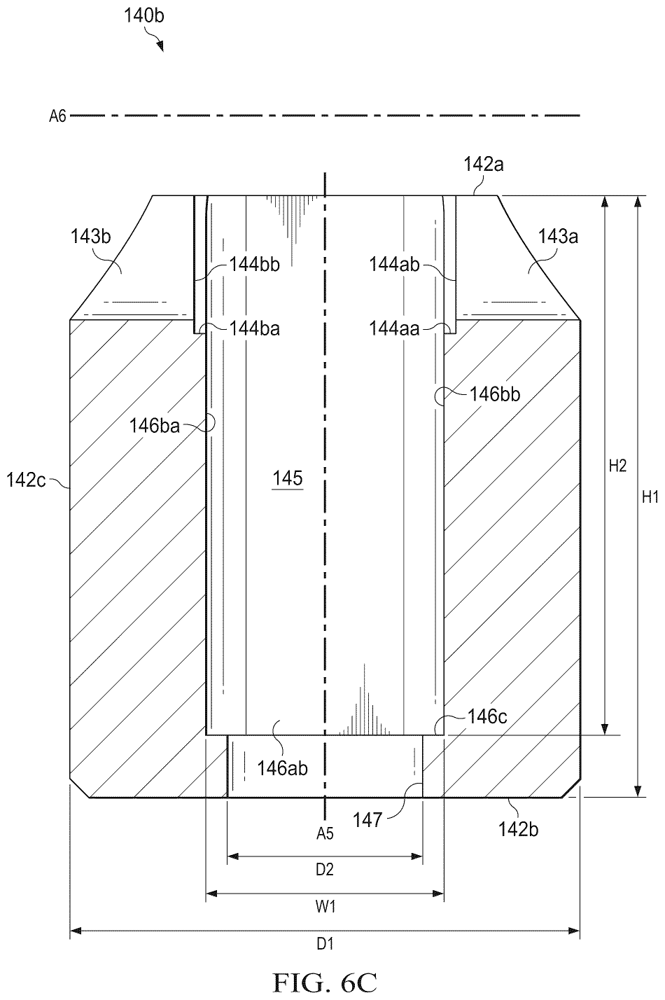

Referring to FIGS. 6A-6C, with continuing reference to FIGS. 2A-2B and 3-5, the gate guide 140b, which includes or is part of the balancing end bonnet assembly 135, is illustrated, according to one or more embodiments of the present disclosure, with FIG. 6B illustrating a cross-section of the gate guide of FIG. 6A taken along the line 6B-6B of FIG. 6A, and FIG. 6C illustrating another cross-section of the gate guide of FIG. 6A taken along the line 6B-6B of FIG. 6A. The gate guide 140b defines opposing end faces 142a, 142b and an outer surface 142c encompassing the gate guide 140b therebetween along a center axis A5. In one or more embodiments, the outer surface 142c is generally cylindrical. The gate guide 140b has a diameter D1 (of the outer surface 142c) and a height H1 (from the end face 142a to the end face 142b). An internal region 145 is formed through the end face 142a and into the end face 142b along the center axis A5. In one or more embodiments, the internal region 145 is a generally rectangular prism, defining surfaces 146aa, 146ab, 146ba, 146bb, 146c in the gate guide 140b. Specifically, the surfaces 146aa, 146ab, 146ba, 146bb, 146c in the gate guide 140b are generally planar, with the surfaces 146aa, 146ab being spaced in a parallel relation, the surfaces 146ba, 146bb being spaced in a generally parallel relation perpendicular to the surfaces 146aa, 146bb, and the surface 146c being perpendicular to the surfaces 146aa, 146ab, 146ba, 146bb.

A pair of recesses 143a, 143b are formed along a center axis A6 and through both the end face 142a and the outer surface 142c of the gate guide 140b on opposing sides of the internal region 145. The center axis A6 is perpendicular to the center axis A5 along which the internal region 145 is formed. In one or more embodiments, the recesses 143a, 143b are generally semi-cylindrical. The recesses 143a, 143b have a radius R1 (from the center axis A6). In one or more embodiments, The radius R1 of the recesses 143a, 143b is less than half of the diameter D1 of the gate guide 140b (at the outer surface 142c). A semi-annular recess 144aa is formed in the gate guide 140b adjacent the recess 143a and the internal region 145. The semi-annular recess 144aa adjoins the surface 146bb and defines an annular shoulder 144ab in the gate guide 140b. A semi-annular recess 144ba is formed in gate guide 140b adjacent the recess 143b and the internal region 145. The semi-annular recess 144ba adjoins the surface 146ba and defines an annular shoulder 144bb in the gate guide 140b.

The internal region has a height H2 (from the end face 142a to the surface 146c), a length L1 (from the surface 146aa to the surface 146ab), and a width W1 (from the surface 146ba to the surface 146bb). In one or more embodiments, although the internal region 145 is a generally rectangular prism, the gate guide 140b may be radiused between the surfaces 146aa, 146ba, between the surfaces 146ba, 146ab, between the surfaces 146ab, 146bb, and between the surfaces 146bb, 146aa. An internal passage 147 extends along the center axis A5 through the gate guide 140b, including the surface 146c and the end face 142b. In one or more embodiments, the internal passage 147 is generally cylindrical. The internal passage 147 has a diameter D2. In one or more embodiments, the diameter D2 is less than both the length L1 (from the surface 146aa to the surface 146ab) and the width W1 (from the surface 146ba to the surface 146bb) of the internal region 145. One or more openings 148 are also formed through the gate guide 140b through the gate guide 140b, including the surface 146c and the end face 142b. The one or more openings 148 are adapted to accommodate the one or more fasteners 141b that connect the gate guide 140b to the bonnet body 126′ of the balancing end bonnet assembly 135.

Referring back to FIGS. 2A-2B, with continuing reference to FIGS. 6A-6C, when the gate valve 100′ is fully assembled for use, the gate guides 140a-b help keep the gate body 116′ on track, remove empty space that would otherwise be taken up by grease, and isolate the turbulence of the fluid flowing through the gate valve 100′ when the gate body 116′ is stroked between the open configuration and the closed configuration.

The gate guide 140b is connected to the bonnet body 126′ of the balancing end bonnet assembly 135 by the one or more fasteners 141b so that: the center axis A5 of the gate guide 140b is substantially co-axial with the center axis A1′ of the gate valve 100′; and the center axis A6 of the gate guide 140b is substantially co-axial with the center axes A2′, A3′, A4′ of the gate valve 100′. The balance stem 118a′ extends within the internal passage 147 of the gate guide 140b, which internal passage 147 is adapted to accommodate the gate nut 118b′ in the fully-closed configuration of the gate valve 100′. The recess 143a of the gate guide 140b accommodates the seat element 109a′ so that the annular ridge 113 is received by the semi-annular recess 144aa. The recess 143b of the gate guide 140b accommodates the seat element 109b′ in a manner similar to the manner in which the recess 143a of the gate guide 140b accommodates the seat element 109a′. The gate body 116′ extends within the internal region 145 of the gate guide 140b and is constrained between the surfaces 146ba, 146bb. However, in one or more embodiments, rather than being similarly constrained between the surfaces 146aa, 146ab of the gate guide 140b, the gate body 116′ is slightly spaced apart from the surfaces 146aa, 146ab, thus permitting a reduced volume of grease between the gate body 116′ and the surfaces 146aa, 146ab.

The gate guide 140a is substantially identical (or at least similar) to the gate guide 140b, except that, rather than being connected to the bonnet body 126′ of the balancing end bonnet assembly 135 via the one or more fasteners 141b, the gate guide 140a is connected to the bonnet body 121′ of the operating end bonnet assembly 130 via the one or more fasteners 141a. The various feature(s)/component(s) of the gate guide 140a that are substantially identical to corresponding feature(s)/component(s) of the gate guide 140b are given the same reference numerals, except with the suffix “″” added. The center axis A5″ of the gate guide 140a is substantially co-axial with the center axis A1′ of the gate valve 100′, and the center axis A6″ of the gate guide 140a is substantially co-axial with the center axes A2′, A3′, A4′ of the gate valve 100′. The operating stem 117a′ extends within the internal passage 147″ of the gate guide 140a, which internal passage 147″ accommodates the gate nut 117b′ in the fully-open configuration of the gate valve 100′. The recess 143a″ of the gate guide 140a accommodates the seat element 109a′ so that the annular ridge 113′ is received by the semi-annular recess 144aa″. The recess 143b″ of the gate guide 140a accommodates the seat element 109b′ in a manner similar to the manner in which the recess 143a″ of the gate guide 140a accommodates the seat element 109a′. The gate body 116′ extends within the internal region 145″ of the gate guide 140a and is constrained between the surfaces 146ba″, 146bb″. In one or more embodiments, rather than being similarly constrained between the surfaces 146aa″, 146ab″ of the gate guide 140a, the gate body 116′ is slightly spaced apart from the surfaces 146aa″, 146ab″, thus permitting a reduced volume of grease between the gate body 116′ and the surfaces 146aa″, 146ab″.

In one or more embodiments, a method of assembling the gate valve 100′ includes placing the gate valve 100′ in the assembled condition described above and illustrated in FIGS. 2A-2B. In one or more embodiments, a method of disassembling the gate valve 100′ includes placing the gate valve 100′ in an unassembled condition.

In one or more embodiments, a method of retrofitting the gate valve 100 includes at least partially disassembling the gate valve 100, removing the gate guides 111a, 111b, and reassembling the gate valve 100 with the gate guides 140a, 140b. In one or more embodiments, the ability to retrofit the gate valve 100 increases the operational life of the gate valve 100 as a whole.

In one or more embodiments, at least partially disassembling the gate valve 100 to, for example, retrofit the gate valve 100 in accordance with the foregoing, includes: disconnecting the operating end bonnet assembly 120 from the valve body 105, disconnecting the balancing end bonnet assembly 125 from the valve body 105, removing the gate assembly 115 from the valve body 105 to provide access to the internal region 106, and removing the valve seats 110a, 110b from the valve body 105.

It is understood that one or more of the embodiments described above and shown FIGS. 1A through 6C may be combined in whole or in part with one or more of the other embodiments described above and shown in FIGS. 1A through 6C.

A gate valve has been disclosed according to one or more embodiments of the present disclosure. The gate valve generally includes: a valve body; opposing first and second seat elements; a gate body seated against the opposing first and second seat elements and movable between an open configuration and a closed configuration; and a first gate guide, including: opposing first and second end faces; a first internal region formed through the first end face; a first outer surface encompassing the first gate guide, including the first internal region, between the opposing first and second end faces; and opposing first and second recesses formed through both the first outer surface and the first end face on opposing sides of the first internal region; wherein the opposing first and second seat elements, the gate body, and the first gate guide extend within the valve body; wherein the gate body extends within the first internal region of the first gate guide; and wherein the opposing first and second seat elements extend within the opposing first and second recesses, respectively, of the first gate guide. In one or more embodiments, the gate valve further includes a first bonnet body connected to the valve body; wherein the first gate guide is connected to the first bonnet body. In one or more embodiments, the first internal region defines opposing first and second surfaces in the first gate guide, said opposing first and second surfaces being: spaced in a parallel relation; and adapted to constrain the gate body during movement between the open configuration and the closed configuration. In one or more embodiments, the first gate guide further includes: a first semi-annular recess formed adjacent both the first recess and the first internal region; and a second semi-annular recess formed adjacent both the second recess and the first internal region; wherein a first annular ridge extending radially outward from an exterior of the first seat element extends within the first semi-annular recess of the first gate guide; and wherein a second annular ridge extending radially outward from an exterior of the second seat element extends within the second semi-annular recess of the first gate guide. In one or more embodiments, the first internal region of the first gate guide is formed along a first axis; and the opposing first and second recesses of the first gate guide are formed along a second axis that is perpendicular to the first axis. In one or more embodiments, the first outer surface of the first gate guide has a diameter; and the opposing first and second recesses of the first gate guide each have a radius that is less than half of the diameter of the first outer surface. In one or more embodiments, the gate valve further includes a second gate guide, the second gate guide including: opposing third and fourth end faces; a second internal region formed through the third end face; a second outer surface encompassing the second gate guide, including the second internal region, between the opposing third and fourth end faces; and opposing third and fourth recesses formed through both the second outer surface and the third end face on opposing sides of the second internal region; wherein the gate body extends within the second internal region of the second gate guide; and wherein the opposing first and second seat elements extend within the opposing third and fourth recesses, respectively, of the second gate guide. In one or more embodiments, the gate valve further includes: a first bonnet body connected to the valve body, wherein the first gate guide is connected to the first bonnet body; and a second bonnet body connected to the valve body, opposite the first bonnet body, wherein the second gate guide is connected to the second bonnet body.

A bonnet assembly for a gate valve has also been disclosed according to one or more embodiments of the present disclosure. The gate valve generally includes a valve body in which a gate body is adapted to be seated against opposing first and second seat elements so as to be movable between an open configuration and a closed configuration. The bonnet assembly generally includes: a bonnet body adapted to be connected to the valve body; and a gate guide adapted to be connected to the bonnet body, the gate guide including: opposing first and second end faces; an internal region formed through the first end face; an outer surface encompassing the gate guide, including the internal region, between the opposing first and second end faces; and opposing first and second recesses formed through both the outer surface and the first end face on opposing sides of the internal region; wherein the internal region of the gate guide is adapted to receive the gate body, and the opposing first and second recesses of the gate guide are adapted to receive the opposing first and second seat elements, respectively, when: the gate body is seated against the opposing first and second seat elements in the valve body so as to be movable between the open configuration and the closed configuration; the gate guide is connected to the bonnet body; and the bonnet body is connected to the valve body. In one or more embodiments, the internal region defines opposing first and second surfaces in the gate guide, said opposing first and second surfaces being: spaced in a parallel relation; and adapted to constrain the gate body during movement between the open configuration and the closed configuration. In one or more embodiments, the internal region also defines opposing third and fourth surfaces in the gate guide, said opposing third and fourth surfaces being spaced in a parallel relation perpendicular to the opposing first and second surfaces. In one or more embodiments, the gate guide further includes: a first semi-annular recess formed adjacent both the first recess and the internal region; and a second semi-annular recess formed adjacent both the second recess and the internal region; and the first semi-annular recess of the gate guide is adapted to receive a first annular ridge extending radially outward from an exterior of the first seat element, and the second semi-annular recess of the gate guide is adapted to receive a second annular ridge extending radially outward from an exterior of the second seat element, when: the gate body is seated against the opposing first and second seat elements in the valve body so as to be movable between the open configuration and the closed configuration; the gate guide is connected to the bonnet body; and the bonnet body is connected to the valve body. In one or more embodiments, the internal region of the gate guide is formed along a first axis; and the opposing first and second recesses of the gate guide are formed along a second axis that is perpendicular to the first axis. In one or more embodiments, the outer surface of the gate guide has a diameter; and the opposing first and second recesses of the gate guide each have a radius that is less than half of the diameter of the outer surface.

A gate guide for a gate valve has also been disclosed according to one or more embodiments of the present disclosure. The gate valve generally includes a valve body in which a gate body is adapted to be seated against opposing first and second seat elements so as to be movable between an open configuration and a closed configuration. The gate guide generally includes: opposing first and second end faces; an internal region formed through the first end face; an outer surface encompassing the gate guide, including the internal region, between the opposing first and second end faces; and opposing first and second recesses formed through both the outer surface and the first end face on opposing sides of the internal region; wherein the internal region of the gate guide is adapted to receive the gate body, and the opposing first and second recesses of the gate guide are adapted to receive the opposing first and second seat elements, respectively, when: the gate body is seated against the opposing first and second seat elements in the valve body so as to be movable between the open configuration and the closed configuration. In one or more embodiments, the internal region defines opposing first and second surfaces in the gate guide, said opposing first and second surfaces being: spaced in a parallel relation; and adapted to constrain the gate body during movement between the open configuration and the closed configuration. In one or more embodiments, the internal region also defines opposing third and fourth surfaces in the gate guide, said opposing third and fourth surfaces being spaced in a parallel relation perpendicular to the opposing first and second surfaces. In one or more embodiments, the gate guide further includes: a first semi-annular recess formed adjacent both the first recess and the internal region; and a second semi-annular recess formed adjacent both the second recess and the internal region; and the first semi-annular recess of the gate guide is adapted to receive a first annular ridge extending radially outward from an exterior of the first seat element, and the second semi-annular recess of the gate guide is adapted to receive a second annular ridge extending radially outward from an exterior of the second seat element, when: the gate body is seated against the opposing first and second seat elements in the valve body so as to be movable between the open configuration and the closed configuration; the gate guide is connected to the bonnet body; and the bonnet body is connected to the valve body. In one or more embodiments, the internal region of the gate guide is formed along a first axis; and the opposing first and second recesses of the gate guide are formed along a second axis that is perpendicular to the first axis. In one or more embodiments, the outer surface of the gate guide has a diameter; and the opposing first and second recesses of the gate guide each have a radius that is less than half of the diameter of the outer surface.

It is also understood that variations may be made in the foregoing without departing from the scope of the disclosure.

In one or more embodiments, the elements and teachings of the various embodiments disclosed herein may be combined in whole or in part in some or all of said embodiment(s). In addition, one or more of the elements and teachings of the various embodiments disclosed herein may be omitted, at least in part, or combined, at least in part, with one or more of the other elements and teachings of said embodiment(s).

Any spatial references such as, for example, “upper,” “lower,” “above,” “below,” “between,” “bottom,” “vertical,” “horizontal,” “angular,” “upwards,” “downwards,” “side-to-side,” “left-to-right,” “left,” “right,” “right-to-left,” “top-to-bottom,” “bottom-to-top,” “top,” “bottom,” “bottom-up,” “top-down,” etc., are for the purpose of illustration only and do not limit the specific orientation or location of the structure described above.

In one or more embodiments, while different steps, processes, and procedures are described as appearing as distinct acts, one or more of the steps, one or more of the processes, or one or more of the procedures may also be performed in different orders, simultaneously or sequentially. In one or more embodiments, the steps, processes, or procedures may be merged into one or more steps, processes, or procedures. In one or more embodiments, one or more of the operational steps in each embodiment may be omitted. Moreover, in some instances, some features of the present disclosure may be employed without a corresponding use of the other features. Moreover, one or more of the embodiments disclosed above, or variations thereof, may be combined in whole or in part with any one or more of the other embodiments described above, or variations thereof.

Although various embodiments have been disclosed in detail above, the embodiments disclosed are exemplary only and are not limiting, and those skilled in the art will readily appreciate that many other modifications, changes, and substitutions are possible in the embodiments without materially departing from the novel teachings and advantages of the present disclosure. Accordingly, all such modifications, changes, and substitutions are intended to be included within the scope of this disclosure as defined in the following claims. In the claims, means-plus-function clauses are intended to cover the structures described herein as performing the recited function and not only structural equivalents, but also equivalent structures. Moreover, it is the express intention of the applicant not to invoke 35 U.S.C. § 112(f) for any limitations of any of the claims herein, except for those in which the claim expressly uses the word “means” together with an associated function.

What is claimed is:

1. A gate valve, comprising:
a valve body;
opposing first and second seat elements;
a gate body seated against the opposing first and second seat elements and movable between an open configuration and a closed configuration; and
a first gate guide, comprising:
opposing first and second end faces;
a first internal region formed through the first end face;
a first outer surface encompassing the first gate guide, including the first internal region, between the opposing first and second end faces; and
opposing first and second recesses formed through both the first outer surface and the first end face on opposing sides of the first internal region;
wherein the opposing first and second seat elements, the gate body, and the first gate guide extend within the valve body;
wherein the gate body extends within the first internal region of the first gate guide; and
wherein the opposing first and second seat elements extend within the opposing first and second recesses, respectively, of the first gate guide.

2. The gate valve of claim 1, further comprising:
a first bonnet body connected to the valve body;
wherein the first gate guide is connected to the first bonnet body.

3. The gate valve of claim 1, wherein the first internal region defines opposing first and second surfaces in the first gate guide, said opposing first and second surfaces being:
spaced in a parallel relation; and
adapted to constrain the gate body during movement between the open configuration and the closed configuration.

4. The gate valve of claim 1,
wherein the first gate guide further comprises:
a first semi-annular recess formed adjacent both the first recess and the first internal region; and
a second semi-annular recess formed adjacent both the second recess and the first internal region;
wherein a first annular ridge extending radially outward from an exterior of the first seat element extends within the first semi-annular recess of the first gate guide; and
wherein a second annular ridge extending radially outward from an exterior of the second seat element extends within the second semi-annular recess of the first gate guide.

5. The gate valve of claim 1,
wherein the first internal region of the first gate guide is formed along a first axis; and
wherein the opposing first and second recesses of the first gate guide are formed along a second axis that is perpendicular to the first axis.

6. The gate valve of claim 1,
wherein the first outer surface of the first gate guide has a diameter; and
wherein the opposing first and second recesses of the first gate guide each have a radius that is less than half of the diameter of the first outer surface.

7. The gate valve of claim 1, further comprising:
a second gate guide, comprising:
opposing third and fourth end faces;
a second internal region formed through the third end face;
a second outer surface encompassing the second gate guide, including the second internal region, between the opposing third and fourth end faces; and
opposing third and fourth recesses formed through both the second outer surface and the third end face on opposing sides of the second internal region;
wherein the gate body extends within the second internal region of the second gate guide; and
wherein the opposing first and second seat elements extend within the opposing third and fourth recesses, respectively, of the second gate guide.

8. The gate valve of claim 7, further comprising:
a first bonnet body connected to the valve body, wherein the first gate guide is connected to the first bonnet body; and
a second bonnet body connected to the valve body, opposite the first bonnet body, wherein the second gate guide is connected to the second bonnet body.

9. A bonnet assembly for a gate valve, the gate valve including a valve body in which a gate body is adapted to be seated against opposing first and second seat elements so as to be movable between an open configuration and a closed configuration, the bonnet assembly comprising:
a bonnet body adapted to be connected to the valve body; and
a gate guide adapted to be connected to the bonnet body, the gate guide comprising:
opposing first and second end faces;
an internal region formed through the first end face;
an outer surface encompassing the gate guide, including the internal region, between the opposing first and second end faces; and
opposing first and second recesses formed through both the outer surface and the first end face on opposing sides of the internal region;
wherein the internal region of the gate guide is adapted to receive the gate body, and the opposing first and second recesses of the gate guide are adapted to receive the opposing first and second seat elements, respectively, when:
the gate body is seated against the opposing first and second seat elements in the valve body so as to be movable between the open configuration and the closed configuration;
the gate guide is connected to the bonnet body; and
the bonnet body is connected to the valve body.

10. The bonnet assembly of claim 9, wherein the internal region defines opposing first and second surfaces in the gate guide, said opposing first and second surfaces being:
spaced in a parallel relation; and
adapted to constrain the gate body during movement between the open configuration and the closed configuration.

11. The bonnet assembly of claim 10, wherein the internal region also defines opposing third and fourth surfaces in the gate guide, said opposing third and fourth surfaces being spaced in a parallel relation perpendicular to the opposing first and second surfaces.

12. The bonnet assembly of claim 9, wherein the gate guide further comprises:
a first semi-annular recess formed adjacent both the first recess and the internal region; and
a second semi-annular recess formed adjacent both the second recess and the internal region;
and
wherein the first semi-annular recess of the gate guide is adapted to receive a first annular ridge extending radially outward from an exterior of the first seat element, and the second semi-annular recess of the gate guide is adapted to receive a second annular ridge extending radially outward from an exterior of the second seat element, when:
the gate body is seated against the opposing first and second seat elements in the valve body so as to be movable between the open configuration and the closed configuration;
the gate guide is connected to the bonnet body; and
the bonnet body is connected to the valve body.

13. The bonnet assembly of claim 9, wherein the internal region of the gate guide is formed along a first axis; and
wherein the opposing first and second recesses of the gate guide are formed along a second axis that is perpendicular to the first axis.

14. The bonnet assembly of claim 9, wherein the outer surface of the gate guide has a diameter; and
wherein the opposing first and second recesses of the gate guide each have a radius that is less than half of the diameter of the outer surface.

15. A gate guide for a gate valve, the gate valve including a valve body in which a gate body is adapted to be seated against opposing first and second seat elements so as to be movable between an open configuration and a closed configuration, the gate guide comprising:
opposing first and second end faces;
an internal region formed through the first end face;
an outer surface encompassing the gate guide, including the internal region, between the opposing first and second end faces; and
opposing first and second recesses formed through both the outer surface and the first end face on opposing sides of the internal region;
wherein the internal region of the gate guide is adapted to receive the gate body, and the opposing first and second recesses of the gate guide are adapted to receive the opposing first and second seat elements, respectively, when:
the gate body is seated against the opposing first and second seat elements in the valve body so as to be movable between the open configuration and the closed configuration.

16. The gate guide of claim 15, wherein the internal region defines opposing first and second surfaces in the gate guide, said opposing first and second surfaces being:
spaced in a parallel relation; and
adapted to constrain the gate body during movement between the open configuration and the closed configuration.

17. The gate guide of claim 16, wherein the internal region also defines opposing third and fourth surfaces in the gate guide, said opposing third and fourth surfaces being spaced in a parallel relation perpendicular to the opposing first and second surfaces.

18. The gate guide of claim 15, wherein the gate guide further comprises:
a first semi-annular recess formed adjacent both the first recess and the internal region; and
a second semi-annular recess formed adjacent both the second recess and the internal region;
and
wherein the first semi-annular recess of the gate guide is adapted to receive a first annular ridge extending radially outward from an exterior of the first seat element, and the second semi-annular recess of the gate guide is adapted to receive a second annular ridge extending radially outward from an exterior of the second seat element, when:
the gate body is seated against the opposing first and second seat elements in the valve body so as to be movable between the open configuration and the closed configuration.

19. The gate guide of claim 15, wherein the internal region of the gate guide is formed along a first axis; and
wherein the opposing first and second recesses of the gate guide are formed along a second axis that is perpendicular to the first axis.

20. The gate guide of claim 15, wherein the outer surface of the gate guide has a diameter; and
wherein the opposing first and second recesses of the gate guide each have a radius that is less than half of the diameter of the outer surface.
